(19) United States
(12) Patent Application Publication
(10) Pub. No.: US 2016/0097626 A1
(43) Pub. Date: Apr. 7, 2016

(54) PROBES, STYLI, SYSTEMS INCORPORATING SAME AND METHODS OF MANUFACTURE

(71) Applicant: US Synthetic Corporation, Orem, UT (US)

(72) Inventors: David P. Miess, Highland, UT (US); Mark P. Chapman, Provo, UT (US); Brent A. Lingwall, Spanish Fork, UT (US)

(73) Assignee: US SYNTHETIC CORPORATION, Orem, UT (US)

(21) Appl. No.: 14/876,205

(22) Filed: Oct. 6, 2015

Related U.S. Application Data
(60) Provisional application No. 62/060,418, filed on Oct. 6, 2014.

(51) Int. Cl. G01B 5/016

(52) U.S. Cl. CPC G01B 5/016

(57) ABSTRACT

A probe for use with measuring equipment, such as a coordinate measuring machine (CMM) or a profilometer includes a shaft and a probe tip coupled with the shaft. At least a portion of the probe tip comprises a superabrasive material such as polycrystalline diamond. The probe tip may exhibit a variety of different geometries including, for example, substantially spherical, substantially cylindrical with a high aspect (length to diameter) ratio, or substantially disc-shaped. In other embodiments, the tip may include a converging portion leading to a fine-radiussed end point. The tip may be manufactured by forming a body using a high-pressure, high-temperature (HPHT) process and the shaping the body using a process such as electrical discharge machining (EDM), grinding or laser cutting.

### CROSS-REFERENCE TO RELATED APPLICATIONS

This application claims the benefit of provisional application Ser. No. 62/060,418, filed on Oct. 6, 2014, the disclosure of which is hereby incorporated by reference in its entirety.

### BACKGROUND

Probes and styli are used in various machines and manufacturing processes. For example, probes are used in so-called coordinate-measuring machines (CMMs) in association with measuring the physical geometrical characteristics of an object. Such measurements may be taken, for example, in a quality assurance program to determine whether a part or component has be manufactured in accordance with specified tolerances. The CMM may be manually controlled by an operator, or it may be computer controlled. A probe is fitted to a CMM and the probe is displaced, such as by drive motors, to physically contact a work piece or object. Upon contact of the probe with the work piece, the position of the probe in three-dimensional space is recorded, such as by a computer.

Some examples of CMMs and their use are described in U.S. Pat. No. 8,316,553, issued on Nov. 27, 2012, to Matsumiya et al., and U.S. Pat. No. 7,685,726, issued on Mar. 30, 2010, to Fuchs et al., the disclosures of which are incorporated by reference herein in their entireties.

The probes used in CMMs (and in other robotic applications) conventionally include tips, the portion contacting a work piece, constructed from hard materials such as sapphire, ruby, SiN or WC. The probes are generally considered to be a consumable product since they wear or often have metal or other material residue embedded within their surfaces after some use. Thus, the probes may begin to provide inaccurate results over time.

Probes or styli are also used in machines known as profilometers. A profilometer is a measuring instrument that is used to measure the profile of an object's surface in order to quantify the roughness of the surface. In operation, the stylus of a profilometer is placed in contact with a surface of an object and then the object is displaced relative to the stylus such that its surface is traversed by stylus while the stylus remains in contact with the surface as the object is displaced. The “vertical” displacement of the stylus (relative to the surface being traversed) is recorded as the stylus traverses the object in order to provide a profile of the surface. An example of a profilometer is described, for example, in U.S. Pat. No. 6,763,319, issued on Jul. 13, 2004, to Handa et al., the disclosure of which is incorporated by reference herein in its entirety. Conventional styli may become worn, or may not be capable of holding a fine enough radius on the tip to provide a desired resolution of the surface profile.

### BRIEF SUMMARY OF THE INVENTION

In accordance with the present invention, various embodiments of probes are provided for use with measuring equipment. In accordance with one embodiment, a probe for use with a measuring machine comprises a shaft and a tip coupled to the shaft, the tip comprising polycrystalline diamond.

In one embodiment, the tip exhibits a substantially spherical geometry and may exhibit a diameter of approximately 0.5 mm to approximately 35 mm.

In one embodiment, the tip exhibits a substantially cylindrical geometry. In another embodiment, the tip is substantially disc-shaped.

In one embodiment, the shaft includes a threaded coupling portion.

In one embodiment, the polycrystalline diamond comprises a body of bonded diamond grains defining interstitial spaces between the diamond grains. In one particular embodiment, at least some of the interstitial spaces contain a catalyst material.

In one embodiment, the shaft comprises a coupling arm and a lateral extension connected with the coupling arm. In one particular embodiment, the lateral extension and the coupling arm comprise a unitary member.

In one embodiment, the tip is coupled with the lateral extension. The tip may include a converging portion having a fine-radiused end point. In one particular embodiment, the fine radiused end point exhibits a radius of approximately 4 micrometers or smaller.

In accordance with another embodiment of the present invention, a method is provided for forming a probe for use with a measuring machine. The method comprises providing a shaft, forming a probe tip, shaping the tip and coupling the tip to the shaft. The act of forming a probe tip includes sintering a volume of diamond grains under high-pressure, high-temperature (HPHT) conditions.

In one embodiment, shaping the tip includes shaping the tip using at least one of an electrical discharge machine (EDM) process, grinding and laser cutting.

In one embodiment, shaping the tip includes shaping the tip to exhibit at least one of a substantially spherical and a substantially cylindrical geometry.

In one embodiment shaping the tip includes shaping the tip to include a substantially conical portion having a fine-radiused end point. In one particular embodiment, the end point is configured to exhibit a radius of approximately 4 micrometers or less.

In one embodiment, providing a shaft includes forming the shaft to include a coupling arm and a lateral extension. In one particular embodiment, forming the shaft includes brazing the coupling arm and the lateral extension.

In one embodiment, coupling the tip to the shaft includes brazing the tip to the shaft.

In one embodiment, the method includes forming a plurality of threads on the shaft.

Features from any of the various embodiments described herein may be used in combination with one another, without limitation. In addition, other features and advantages of the instant disclosure will become apparent to those of ordinary skill in the art through consideration of the ensuing description, the accompanying drawings, and the appended claims.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a side view of a probe in accordance with an embodiment of the present invention;

FIG. 2 is partial cross-sectional view of a probe according to an embodiment of the invention;

FIG. 3 is partial cross-sectional view of a probe according to another embodiment of the invention;

FIG. 4 is partial cross-sectional view of a probe according to an embodiment of the invention;

FIG. 5 is a partial cross-sectional view of a probe according to an embodiment of the invention;

FIG. 6 is a partial cross-sectional view of a probe according to an embodiment of the invention;

FIG. 7 is a side view of another probe in accordance with an embodiment of the invention;

FIG. 8 is a side view of a probe in accordance with another embodiment of the invention;

FIG. 9 is a side view of a probe in accordance with a further embodiment of the invention;

FIG. 10 is a side view of a probe in accordance with another embodiment of the invention;

FIG. 11 is a side view of a probe in accordance with another embodiment of the invention;

FIGS. 12A and 12B are side and end views of a probe in accordance with an embodiment of the present invention;

FIGS. 13A and 13B are side and end views of a probe in accordance with another embodiment of the present invention;

FIG. 14 is a detailed view of a tip of a probe in accordance with an embodiment of the present invention.

### DETAILED DESCRIPTION OF THE INVENTION

The present invention relates generally to probes and styli, such as may be used for measuring equipment including, for example, coordinate measuring machines (CMMs) and profilometers. The term “superabrasive material,” as used herein, may refer to a material exhibiting a hardness exceeding a hardness of tungsten carbide, such as, for example, polycrystalline diamond.

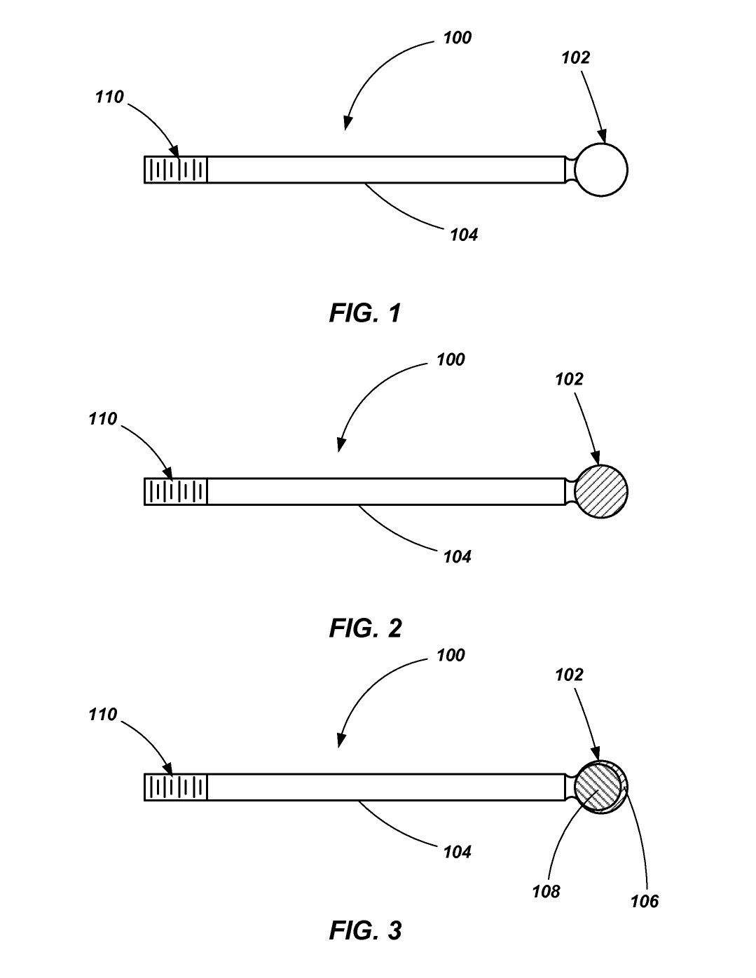

FIG. 1 shows a probe 100 having a tip 102 coupled with a shaft 104. The shaft is configured for coupling with a measuring device and the tip 102 is configured to physically contact an object to be measured or assessed in some manner. The probe 100 may be used, for example, in a CMM device or other apparatus configured for measuring or inspecting a physical object. The tip 102 may include a superabrasive body or element and may, for example, be brazed or otherwise coupled with the shaft.

In one embodiment, the tip 102 may include a body of sintered polycrystalline diamond (PCD) material. Some non-limiting examples of superabrasive bodies or elements are described in U.S. Pat. No. 8,297,382 to Bertagnolli et al., issued Oct. 30, 2012, U.S. Pat. No. 8,079,431 to Cooley et al., issued Dec. 20, 2011, and U.S. Pat. No. 7,866,418 to Bertagnolli et al., issued Jan. 11, 2011, the disclosures of which are incorporated by reference herein in their entireties. It is noted that, while such patents may describe the use of superabrasive materials in specific examples, such as the manufacture of cutting tools and/or bearing elements, the bodies and methods of manufacture are applicable to other structures including the various probes and styli described herein.

In one embodiment the tip 102 may be formed by subjecting diamond particles in the presence of a catalyst to HPHT (high-pressure, high-temperature) sintering conditions. The catalyst may be, for example, in the form of a powder, a disc or foil. In one embodiment, as shown in FIG. 2 (which shows a cross-section of the tip 102), the superabrasive body forming the tip 102 does not include a substrate. Rather, the entire tip 102 is formed as a superabrasive body. However, in other embodiments, such as shown in FIG. 3, the tip 102 may include a superabrasive material layer 106 attached to or formed with a substrate 108.

When formed as a PCD body (or as including a PCD material layer), the tip 102 may be fabricated by subjecting a plurality of diamond particles (e.g., diamond particles having an average particle size between 0.5 μm to about 150 μm) to a HPHT sintering process in the presence of a catalyst, such as a metal-solvent catalyst, cobalt, nickel, iron, a carbonate catalyst, an alloy of any of the preceding metals, or combinations of the preceding catalysts to facilitate intergrowth between the diamond particles and form the PCD table comprising directly bonded-together diamond grains (e.g., exhibiting sp³ bonding) defining interstitial regions with the catalyst disposed within at least a portion of the interstitial regions. In order to effectively HPHT sinter the plurality of diamond particles, the particles and catalyst material may be placed in a pressure transmitting medium, such as a refractory metal can, graphite structure, pyrophyllite or other pressure transmitting structure, or another suitable container or supporting element. The pressure transmitting medium, including the particles and catalyst material, may be subjected to an HPHT process using an HPHT press at a temperature of at least about 1000° C. (e.g., about 1300° C. to about 1600° C.) and a cell pressure of at least 4 GPa (e.g., about 5 GPa to about 10 GPa, or about 7 GPa to about 9 GPa) for a time sufficient to sinter the diamond particles and form a PCD table.

In certain embodiments, such as shown in FIG. 3, a superabrasive element may be formed such that it is bonded to a substrate. In embodiments where the superabrasive elements are formed with a substrate, the substrate may act as a source of the catalyst material (e.g., with the substrate comprising a cemented carbide material). In such an embodiment, the superabrasive element is formed by sintering the diamond (or other superabrasive) particles in the presence of the substrate in a first HPHT process, the substrate may include cobalt-cemented tungsten carbide from which cobalt or a cobalt alloy infiltrates into the diamond particles and catalyzes formation of PCD. For example, the substrate may comprise a cemented carbide material, such as a cobalt-cemented tungsten carbide material or another suitable material. Nickel, iron, and alloys thereof are other catalysts that may form part of the substrate. The substrate may include, without limitation, cemented carbides including titanium carbide, niobium carbide, tantalum carbide, vanadium carbide, and combinations of any of the preceding carbides cemented with iron, nickel, cobalt, or alloys thereof.

As previously noted, in other embodiments, instead of, or in addition to, relying on the substrate to provide a catalyst material during the HPHT process, a catalyst material disc and/or catalyst particles may be mixed with the diamond particles. In some embodiments, the catalyst may be a carbonate catalyst selected from one or more alkali metal carbonates (e.g., one or more carbonates of Li, Na, and K), one or more alkaline earth metal carbonates (e.g., one or more carbonates of Be, Mg, Ca, Sr, and Ba), or combinations of the foregoing. The carbonate catalyst may be partially or substantially completely converted to a corresponding oxide of Li, Na, K, Be, Mg, Ca, Sr, Ba, or combinations after HPHT sintering of the plurality of diamond particles. The diamond particle size distribution of the plurality of diamond particles may exhibit a single mode, or may be a bimodal or greater distribution of grain size. In one embodiment, the diamond particles may comprise a relatively larger size and at least one relatively smaller size. As used herein, the phrases “relatively larger” and “relatively smaller” refer to particle sizes (by any suitable method) that differ by at least a factor of two (e.g., 30 μm as compared to 15 μm). According to various embodiments, the diamond particles may include a portion exhibiting a relatively larger average particle size (e.g., 50 μm, 40 μm, 30 μm, 20 μm, 15 μm, 12 μm, 10 μm, 8 μm) and another portion exhibiting at least one relatively smaller average particle size (e.g., 6 μm, 5 μm, 4 μm, 3 μm, 2 μm, 1 μm, 0.5 μm, less than 0.5 μm, 0.1 μm, less than 0.1 μm). In one embodiment, the diamond particles may include a portion exhibiting a relatively larger average particle size between about 10 μm and about 40 μm and another portion exhibiting a relatively smaller average particle size between about 1 μm and 4 μm. In some embodiments, the diamond particles may comprise three or more different average particle sizes (e.g., one relatively larger average particle size and two or more relatively smaller average particle sizes), without limitation.

When polycrystalline diamond is sintered using a catalyst material, the catalyst material may remain in interstitial spaces between the bonded diamond grains. In various embodiments, at least some of the catalyst material may be removed from the interstitial spaces of the superabrasive material used to form the tip 102. For example, catalyst material may be removed (such as by acid-leaching) to any desired depth from a defined surface of the superabrasive element. Removal of the catalyst material to provide a substantially catalyst free region (or at least a catalyst-lean region) may provide a table that is more thermally stable by removing the catalyst material because the catalyst material often exhibits a substantially different coefficient of thermal expansion than the diamond material, in a region of the table expected to see substantial temperature increases during use. This may provide an advantage when a tip or stylus, such as described below, is used to measure some characteristic of an object or part that is elevated in temperature in comparison to the tip (at least when the tip initially contacts the part).

In one embodiment, as discussed below, catalyst material may be removed from the interstitial areas through the entire body of the superabrasive element, making the entire superabrasive element substantially catalyst free among its insterstitial areas or spaces. At least partial removal of the catalyst material may provide various advantages in various embodiments. For example, because the catalyst material may exhibit a coefficient of thermal expansion that is different from the body of bonded diamonds, damage to the body of bonded diamonds may occur in response to changes in temperatures experienced during use.

The interstitial spaces of the catalyst-free region may remain substantially material free or, in some embodiments, a second material (i.e., a material that is different from the catalyst material) may be introduced into the interstitial spaces from which catalyst material has been removed. This may result in a device having lower porosity (which may be beneficial for applications where the superabrasive element may be submerged) and also provide enhanced toughness or wear characteristics for the superabrasive element. Some examples of materials that may subsequently introduced into such interstitial spaces, and methods of introducing such materials into the interstitial spaces, are set forth in any of the U.S. Patent documents incorporated by reference herein, as well as U.S. Pat. No. 8,061,458 to Bertagnolli et al., issued Nov. 22, 2011, the disclosure of which is incorporated by reference herein in its entirety.

Removal of catalyst material from the interstices of a superabrasive element, and/or infiltration of the interstices with a material different than the catalyst material, enables the superabrasive element to be tailored with regard to electrical properties (e.g., its electrical conductivity or insulative properties). Selectively tailoring the electrical conductivity of the superabrasive element may enable the tip or stylus to be used in conjunction with other measurements, such as measuring contact resistance for an electric current, in addition to measuring physical aspects of a given part. In another embodiment, measuring electrical contact between a work piece and a tip or stylus may provide the ability to position or measure a conductive work piece with reduced force and/or contact between the work piece and the tip or stylus. Particularly, an electrical resistance between the work piece and the tip/styli may be measured until such resistance falls below a threshold level, indicating contact (or near contact) between the work piece and the tip/stylus. This may provide an advantage over tips and styli which are formed of electrically non-conductive materials. Thus, using a material such as PCD, the tip or stylus may be tailored depending on a particular application or environment in which the tip or stylus will be used.

Referring again to FIGS. 1-3, as noted above, the tip 102 may be coupled to the shaft 104 by brazing or by other appropriate means including welding, soldering, adhesive, mechanical fastening means or other known joining methods. In one embodiment, the shaft 104 may be made from a desired material to limit or inhibit bending of the shaft 104 when the probe 104 contacts the surface of an object. In one example embodiment, the shaft may be formed from a stainless steel material. In other embodiments, the shaft may be formed from materials including, for example, tungsten carbide, ceramic materials (e.g., ceramic sintered alumina), carbon fiber, aluminum, ruby, silicon nitride, or zirconia. In one embodiment, the shaft 104, as well as the tip 102, may be formed of a superabrasive material such as PCD. The shaft 104 may include a coupling portion 110 such as a threaded portion (as shown), a keyed or some other coupling mechanism. The shaft may exhibit a length of, for example, from approximately 10 millimeters (mm) to approximately 300 mm and a diameter of, for example, from approximately 2 mm to approximately 10 mm.

As shown in FIGS. 1-3, the probe tip 102 may be configured to exhibit a substantially spherical geometry. In one embodiment, the diameter of the substantially spherical probe tip 102 may be from approximately 0.5 mm to approximately 35 mm.

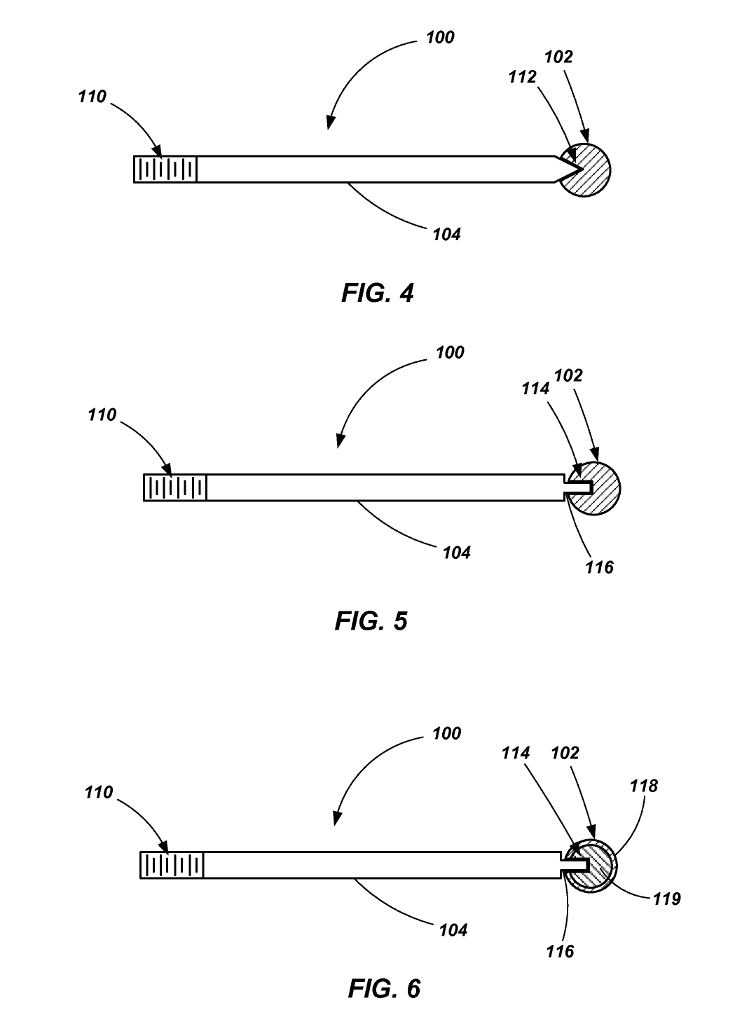

Referring to FIGS. 4-6, additional embodiments of a probe 100 are shown. The embodiments depicted by FIGS. 4-6 may include a probe tip formed using techniques and materials as described above, or may be formed using other techniques and materials. For example, the probe tip 102 may be formed of materials that include solid natural diamond, solid (monocrystalline) synthetic diamond, amorphous diamond like carbon (ADLC), silicon carbide (SiC—including materials referred to as Moissanite and Carborundum) or polycrystalline diamond made from a CVD process. In the case of monocrystalline diamond (natural or synthetic), a diamond body may be shaped (e.g., ground, lased or ablated) into a desired shape and size for use as a probe tip. Similarly, SiC may be cut or otherwise shaped into a desired shape and size for use as a probe tip. With regard to ADLC, such material may be coated on a substrate to form the probe tip. CVD processes may be used to either coat a substrate, or may be grown to a desired size and geometry (e.g., discs that are up to 3 mm thick) and, optionally, subsequently shaped.

Thus, referring to FIG. 4, a probe tip 102 may be formed as a solid material (e.g., solid CVD diamond, PCD material, SiC, or natural monocrystalline diamond) shaped and sized by appropriate processes—in this case as a substantially spherical component—and have a hole 112 formed therein, such as by laser ablation, for coupling with the shaft 104. In one embodiment, the probe tip 102 and shaft 104 may be coupled by way of an adhesive material. Of course, other coupling means are contemplated as well. The hole 112 may be shaped to exhibit a desired geometry such as a conical section, as shown. The use of a conical or other pointed geometry (e.g., pyramidal) may provide increased accuracy in the positioning of the probe tip 102 on the shaft 104.

Referring briefly to FIG. 5, a probe tip 102 may again be formed as a solid material (e.g., solid CVD diamond, PCD material, SiC, or natural monocrystalline diamond) shaped and sized by appropriate processes—in this case as a substantially spherical component—and have a hole 114 formed therein, such as by laser ablation, for coupling with the shaft 104. The hole may exhibit a substantially cylindrical geometry (although not limited to such) and may be sized such that and end 116 of the probe shaft 104 may be press fit or interference fit with the hole 114. In assembling the probe tip 102 with the shaft 104, the probe tip 102 may be heated (causing expansion of the hole 114), and/or the shaft 104 may be cooled (effecting contraction of the end 116 of the shaft 104), to accommodate a fit between the end 116 and the hole 114. Subsequent to fitting the end 116 in the hole 114, the components may be returned to ambient temperature effecting an interference fit of the two components. In other embodiments, the probe tip 102 may be coupled with the shaft 104 by other appropriate means.

Referring briefly to FIG. 6, a probe tip 102 may include a coating of material 118 (e.g., CVD diamond or ADLC material) formed over a metallic substrate 119. Again, a hole 114 may be formed (e.g., laser ablated) in the probe tip 102 and coupled with an end 116 of the shaft 104 such as described above.

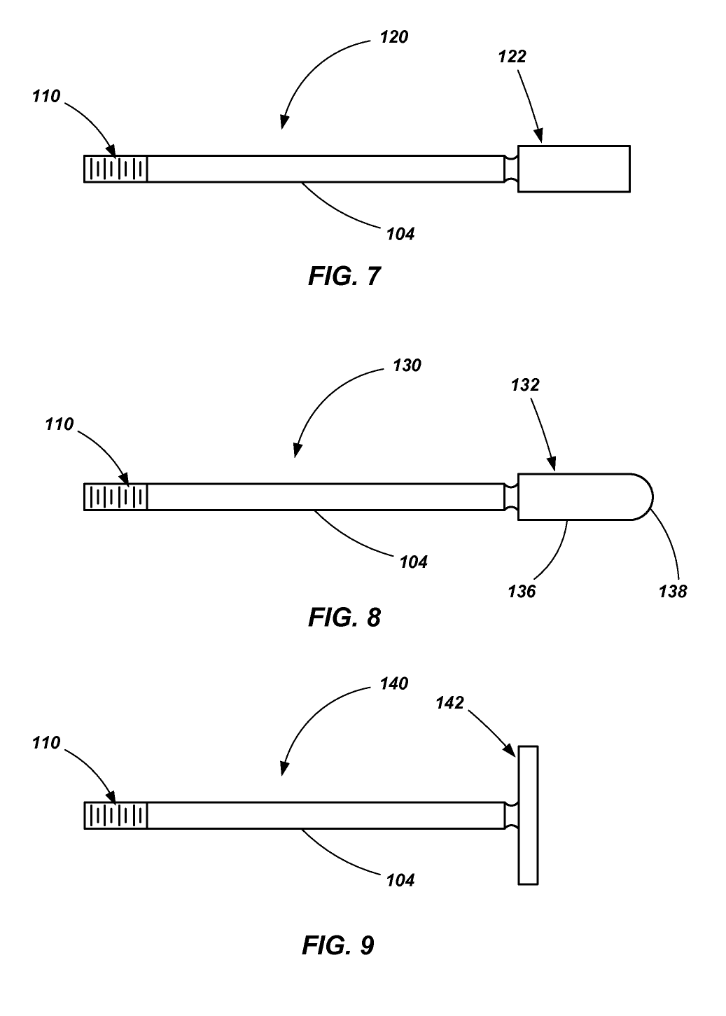

Of course, probes may be configured to include tips with different geometries. For example, a probe 120 is shown in FIG. 7 that includes a shaft 104, such as previously described, and a tip 122 that is configured as a substantially cylindrical body. The substantially cylindrical body may exhibit a geometry such that its length is at least equal to, or greater than, its diameter (i.e., its length to diameter aspect ratio is equal to or greater than 1:1). The tip 122 may comprise a superabrasive material, such as a PCD material or another material as described herein, and may be configured in accordance with previously described methods and techniques. In another example, as shown in FIG. 8, a probe 130 includes a shaft 104 and a tip 132, where the tip is configured to include a substantially cylindrical portion 136 and a substantially hemispherical portion 138. The probe tips 122 and 132 may exhibit diameters (e.g., the cylindrical diameter and/or the hemispherical diameter) similar to those set forth above with respect to the substantially spherical tips.

Referring briefly to FIG. 9, another probe 140 may include a shaft 104 and a tip 142, wherein the tip 142 is disc shaped. In other words, the tip is substantially cylindrical, but with a length to diameter ratio that is less than 1:1 (e.g., 1:2, 1:3 and so on). The tip 142 may comprise a superabrasive material, such as a PCD material, or some other material as described herein, and may be configured in accordance with previously described methods and techniques.

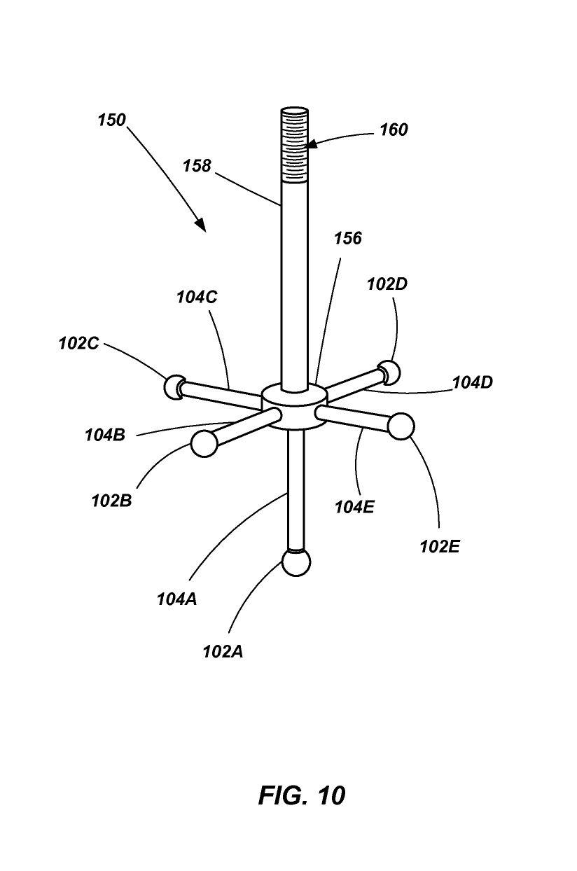

Referring to FIG. 10, a multi-tipped probe device 150 is shown according to another embodiment of the present invention. The device 150 includes a plurality of tips 102A-102E, each coupled with an associated shaft 104A-104E. The shafts 104A-104E are each coupled with a central hub 156. A central shaft 158 is also coupled with the central hub 156 and includes a coupling portion 160 (e.g., a threaded section) for coupling with a measurement machine. The shafts 104A-104E and tips 102A-102E may be configured in accordance with the various embodiments described above.

The shafts 104A-104E and tips 102A-102E may be configured similarly to one another (e.g., exhibit the same size and geometry), or they may be configured differently from one another without any limitation of combination. For example, each of the tips 102A-102E may exhibit a common geometry (e.g., substantially spherical as shown), but with at least two different diameters, or with each exhibiting a unique diameter. In another example, at least two of the tips 102A-102E may exhibit different geometries from one another (e.g., at least one may be substantially spherical while at least one may be substantially cylindrical). The multi-tipped probe device 150 may provide substantial flexibility in measuring various work objects (or various characteristics or features of a given work object) without, for example, having to change probes based on the feature or characteristic being measured.

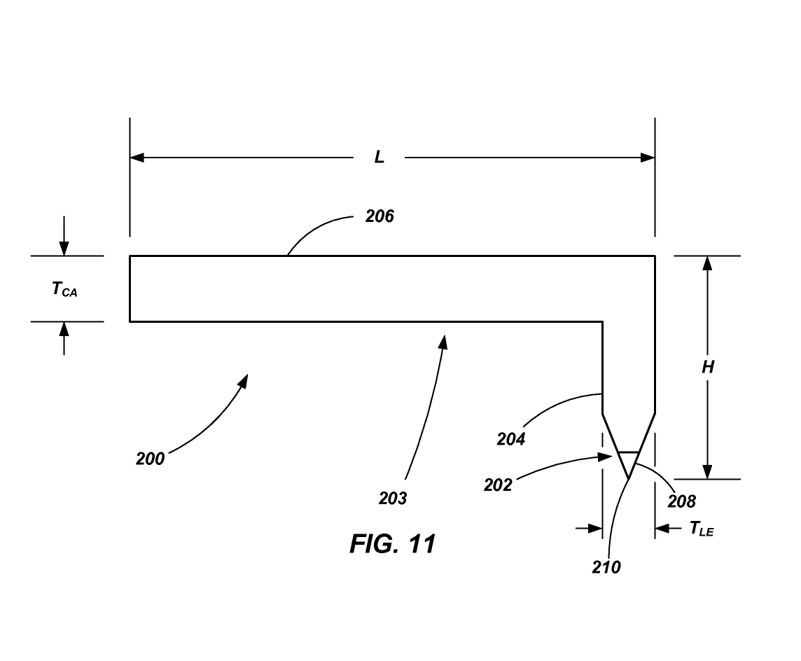

Referring now to FIG. 11, another probe 200 (also referred to as a stylus) is shown in accordance with an embodiment of the present invention. The probe includes a probe tip 202 coupled with a shaft 203. The shaft 203 includes a lateral extension 204 and a coupling arm 206. The coupling arm 206 may be configured for coupling with a measuring machine such as, for example, a profilometer. In the embodiment shown in FIG. 11, the coupling arm 206 and the lateral extension are formed as a unitary member. The coupling arm 206 and lateral extension 204 may be made from a variety of materials, including steel or other metal alloys. In other embodiments, the coupling arm 206 and lateral extension 204 may be formed from the materials set forth above with respect to the shafts of previously described embodiments.

In one embodiment, the lateral extension 204 and the coupling arm 206 may be configured, for example, to exhibit a substantially circular cross-sectional profile. In other embodiments, the lateral extension 204 and the coupling arm 206 may be configured to exhibit different cross-sectional profiles including oval, elliptical, square, rectangular, or other polygonal geometries. In one particular example, the probe 200 exhibits an overall length L of approximately 44.5 mm and an overall height H of approximately 7.6 mm. Additionally, the coupling arm 206 may exhibit a thickness T_{CA} of approximately 2.4 mm while the lateral extension 204 may exhibit a thickness T_{LE} of approximately 1.2 mm.

The tip 202 is coupled with the lateral extension 204 of the shaft 203 and may including a converging section 208 having a fine-radiussed end point 210. The end point 210 may be configured for use in measuring the surface roughness of a selected work piece. At least a portion of the tip 202, including the fine-radiussed end point 210, is formed from a superabrasive material. For example, in one embodiment, at least a portion of the tip 202 may be formed from a PCD material in accordance with methods and techniques such as described above (e.g., formed by laser ablation, lapping, etc.).

In some embodiments, the tip may include a PCD material layer attached to a substrate, the PCD material layer being formed to include the end point 210. The tip 202 may be attached to the lateral extension 204 by brazing, adhesive or other appropriate means. In other embodiments, the tip 202 may be formed as a PCD body (without a substrate) and attached to the lateral extension 204 by similar means.

In one embodiment, the tip 202 may be formed as a part of the lateral extension 204 (e.g., as a unitary structure) and include a superabrasive material layer (e.g., diamond) formed over the lateral extent of the tip 202/lateral extension 204. Such may be formed, for example, by chemical vapor deposition (CVD) or other known processes. Diamond formed by CVD processes differs from PCD material in that the diamond material is formed atom by atom, resulting in a structure that is pure diamond with no binder material. In other words, while still a polycrystalline material, there are no interstitial spaces between diamond grains such as exist in HPHT sintered PCD materials. Some examples of vapor deposition processes are described in U.S. Pat. Nos. 5,439,492, 4,707,384 and 4,645,977, the disclosures of which are each incorporated by reference herein in their entireties.

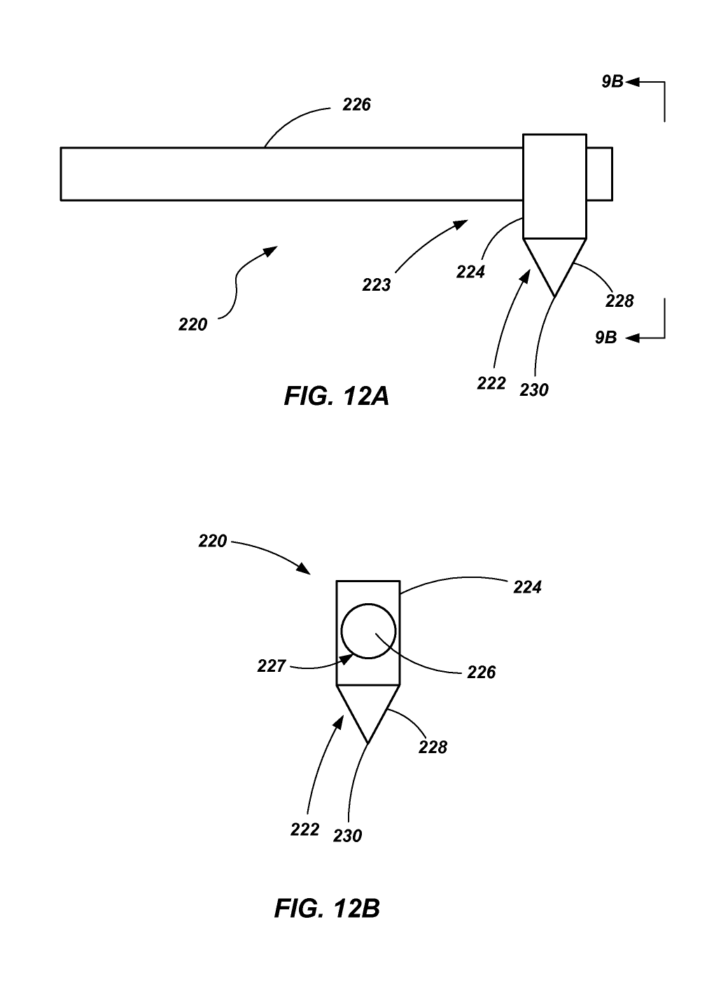

Referring to FIGS. 12A and 12B an embodiment of another probe 220 or stylus is shown, the probe 220 including a probe tip 222 located at the end of shaft 233. The shaft 223 may include a lateral extension 224 connected to a coupling arm 226. The coupling arm 226 may be configured for coupling with a measuring machine such as, for example, a profilometer. In the embodiment shown in FIGS. 12A and 12B, the coupling arm 226 and the lateral extension 224 are formed as separate components with the coupling arm 226 extending through an opening 227 formed in the lateral extension 224. The coupling arm 226 and lateral extension 224 may be coupled to one another by brazing, welding, adhesive, mechanical fasteners, interference fit, or other appropriate means. In one example embodiment, the general dimensions of the probe 220 may be similar to those described above for probe 200, except that the thickness of the lateral extension 224 may be increased for assembly and coupling (e.g., brazing) with the coupling arm 226. For example, the thickness of the lateral extension 224 may be approximately 3 mm.

The tip 222 of the probe 220 again includes a converging section 228 and a fine-radiussed end point 230 for engaging a surface of a work piece or object and is suitable, for example, for use with a profilometer in measuring the surface roughness of the work piece. As with the embodiment described with respect to FIG. 11, at least a portion of the tip 222, including the end point 230, may comprise a superabrasive material and may be formed in a manner such as described above.

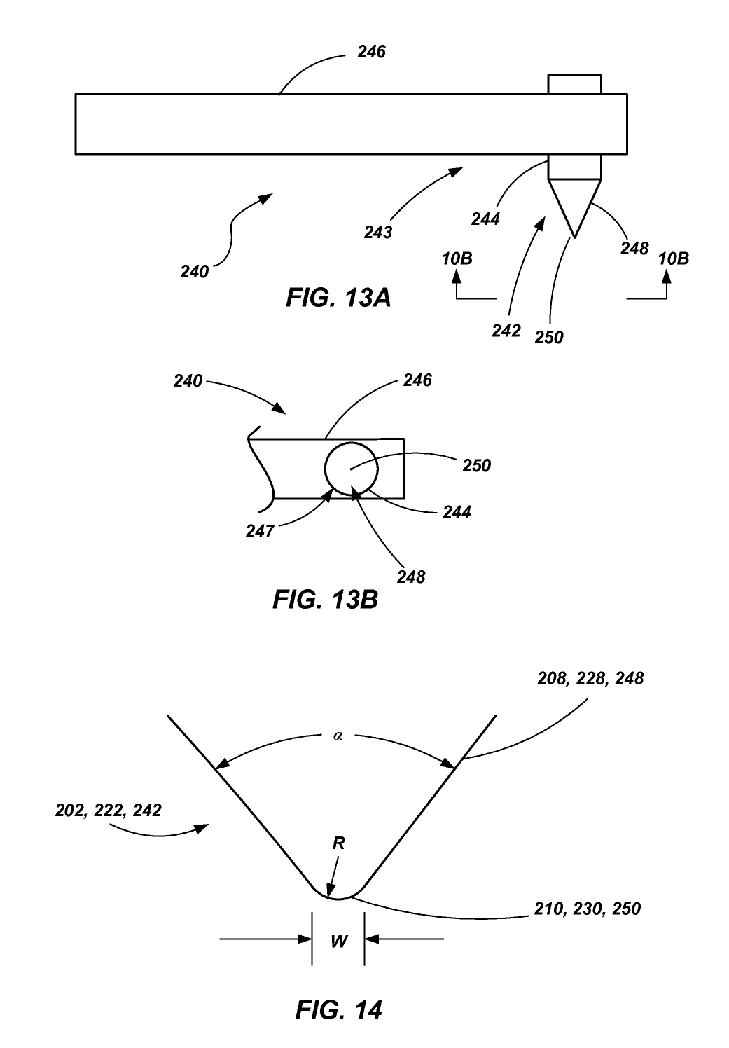

Referring to FIGS. 13A and 13B, another embodiment of a probe 240 is shown. The probe 240 is substantially similar to the probe 220 describe above, having a probe tip 242 coupled with a shaft 243, the shaft including a lateral extension 244 and a coupling arm 246. The coupling arm 246 may be configured for coupling with a measuring machine such as, for example, a profilometer. In the embodiment shown in FIGS. 13A and 13B, the coupling arm 246 and the lateral extension 244 are formed as separate components, similar to the probe 220 described above, but with the lateral extension 244 extending through an opening 247 formed in the coupling arm 246. The coupling arm 246 and lateral extension 244 may be coupled to one another by brazing, welding, adhesive, mechanical fasteners, interference fit, or other appropriate means. In one example embodiment, the general dimensions of the probe 240 may be similar to or the same as those described above for probe 220.

The tip 242 of the probe 240 again includes a converging section 248 having a fine-radiussed end point 250 for engaging a surface of a work piece or object and is suitable, for example, for use with a profilometer in measuring the surface roughness of the work piece. As with previously described embodiments, at least a portion of the tip 242, including the end point 250, may comprise a superabrasive material and may be formed in a manner such as described above.

Having a probe with a fine-radiused tip that is formed of a superabrasive material, such as PCD, enables the end point to be sharpened (and resharpened) to a very small radius using, for example, electrical discharge machining (EDM) processes, grinding, lapping, and/or laser cutting. For example, as illustrated in FIG. 14, tip 202, 222 and 242 of a given probe may include a generally converging portion (208, 228 and 238) which may exhibit an angle α of, for example, approximately 45°. The converging portion may, for example, be configured as a substantially conical section, a substantially pyramidal section, or some other pointed geometry. Additionally, the end point (210, 230 and 250) may exhibit a “width” W of approximately 7 micrometers (μm) or smaller. The “width” W may be defined as the distance between two points on a cross-sectional view of the tip that are located on the periphery where the fine-radiussed end point transitions with the converging surface, as shown in FIG. 14. In one embodiment, the tip 202, 22 and 242 may exhibit a radius R of, for example, approximately 3 microns (μm) to approximately 7 μm. In another embodiment, the fine radius tip may exhibit a radius R of approximately 3 μm or smaller.

In various embodiments, to form a superabrasive tip, the tip may be formed of a PCD material through an HPHT process using diamond grains having an average diameter of less than approximately 20 μm, 10 μm, 5 μm or less than approximately 1 μm and having an increased percentage of cobalt material. In one embodiment, the cobalt content may be approximately 5% to approximately 40% by weight. Unleached PCD (i.e., prior to the removal of any catalyst material) bodies will exhibit higher cobalt content than leached PCD material. Typical unleached PCD material may exhibit between about 10% by weight cobalt to about 5% by weight cobalt. Typical leached PCD material may exhibit less than about 2% by weight cobalt or less than about 1% by weight cobalt. In one embodiment, the cobalt content may be approximately 5% to approximately 10% by weight. In other embodiments, the superabrasive tip may contain less than approximately 8%, less than 6%, or less than 4% cobalt by weight. It is noted that the cobalt content may be affected by grain size of the superabrasive material (e.g., diamond) and/or the HPHT conditions used to sinter the superabrasive material. For example, cobalt content will generally be higher when the superabrasive body is formed of fine grained material as compared to being formed of a more coarse (larger) grained material.

Features from any of the various embodiments described herein may be used in combination with one another, without limitation. In addition, while the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A probe for use with a measuring machine, the probe comprising:
a shaft;
a tip coupled to the shaft, the tip comprising polycrystalline diamond.

2. The probe of claim 1, wherein the tip exhibits a substantially spherical geometry.

3. The probe of claim 2, wherein the tip exhibits a diameter of approximately 0.5 mm to approximately 35 mm.

4. The probe of claim 1, wherein the polycrystalline diamond comprises a body of bonded diamond grains defining interstitial spaces between the diamond grains.

5. The probe of claim 5, wherein at least some of the interstitial spaces contain a catalyst material.

6. The probe of claim 1, wherein the shaft includes a threaded coupling portion.

7. The probe of claim 1, wherein the shaft comprises a coupling arm and a lateral extension.

8. The probe of claim 7, wherein the lateral extension and the coupling arm are a unitary member.

9. The probe of claim 7, wherein the tip is coupled with the lateral extension.

10. The probe of claim 9, wherein the tip comprises a converging portion having a fine-radiussed end point.

11. The probe of claim 10, wherein the fine radiussed end point exhibits a radius of approximately 4 micrometers or smaller.

12. A method of forming a probe for use with a measuring machine, the method comprising:
providing a shaft;
forming a probe tip including:
sintering a volume of diamond grains under high-pressure, high-temperature (HPHT) conditions;
shaping the tip;
coupling the tip to the shaft.

13. The method according to claim 12, wherein shaping the tip includes shaping the tip using at least one of an electrical discharge machine (EDM) process, grinding, lapping and laser ablation.

14. The method according to claim 12, wherein shaping the tip includes shaping the tip to exhibit at least one of a substantially spherical and a substantially cylindrical geometry.

15. The method according to claim 12, wherein shaping the tip includes shaping the tip to include a substantially conical portion having a fine-radiussed end point.

16. The method according to claim 15, further comprising forming the end point to exhibit a radius of approximately 4 micrometers or less.

17. The method according to claim 12, wherein providing a shaft includes forming the shaft to include a coupling arm and a lateral extension.

18. The method according to claim 17, wherein forming the shaft includes brazing the coupling arm and the lateral extension.

19. The method according to claim 12, wherein coupling the tip to the shaft includes brazing the tip to the shaft.

20. The method according to claim 12, further comprising forming a plurality of threads on the shaft.
